(19) United States
(12) Patent Application Publication
(10) Pub. No.: US 2006/0108876 A1
(43) Pub. Date: May 25, 2006

(54) Automatic lighting for input keys of device in unlit area

(76) Inventor: Shary Nassimi, Malibu, CA (US)

Correspondence Address: BOND, SCHOENECK & KING, PLLC, ONE LINCOLN CENTER, SYRACUSE, NY, 13202-1355, US

(21) Appl. No.: 10/995,975

(22) Filed: Nov. 23, 2004

(51) Int. Cl. H01H 33/59

(52) U.S. Cl. 307/139

(57) ABSTRACT

A system for facilitating operation of keys or buttons of an access control or communication system under conditions of low ambient light. For example, a keypad may be mounted adjacent a gate to control a gate actuator in response to operation of keys in a predetermined sequence. A light source is positioned to provide either front or back lighting to the keys and is turned on in response to generation of a signal by a sensor of either physical presence or motion of an infra-red emitting body in proximity to the sensor. The light source may be turned off in response to entry of the proper code on the keypad, or by timing means such as a pulse count generated by a microcontroller which passes or blocks the signal from the sensor which controls illumination of the light source.

### BACKGROUNG OF THE INVENTION

The present invention relates to devices which are operated in response to keypads, pushbuttons or other human interface input which sometimes must be actuated in areas which are unlit or where visibility is limited.

Devices such as those used to control entry access by pressing predetermined keys in a code-actuated system, or simply pressing a call button to activate an intercom system are often located in areas where visibility is limited or which are not illuminated during periods of darkness. Obviously, this interferes with the user's ability to visually identify and operate the desired keys or buttons. Although lights may be installed in or near the input keys or button(s), this can be expensive and either require a constant power drain or the use of timers, causing further expense and ongoing maintenance.

It is a principal object of the present invention to provide means for automatically illuminating a keypad, or other such human interface input, at all times when ambient light levels require such illumination to facilitate visual identification of individual keys or buttons.

It is a further object to provide an illumination system for a human interface input device which operates with extremely low power requirements.

Another object is to provide lighting of a keypad or similar device in response to physical presence of a person in the area of the device under low light conditions, and which turns off the illumination automatically when use of the device is finished.

Other objects will in part be obvious and will in part appear hereinafter.

### SUMMARY OF THE INVENTION

In accordance with the foregoing objects, the invention contemplates the inclusion in or near a user interface input device of a light source having extremely low power requirements, such as an LED. The input device itself may be in the form of a keypad, one or more pushbuttons, or other such manually operable switching means. The light source may be physically located behind the manually operable devices, i.e., to provide backlighting which renders the keys/pushbuttons visually distinguishable to an operator on the front side thereof, or positioned to directly illuminate the keys/buttons, i.e., the light source is on the same side of the keys/buttons as the operator. In either case, a sensing device is incorporated in or positioned adjacent the input device and, through appropriate circuitry, causes the light source to illuminate. The sensing device responds to a threshold level of motion by a person or the presence of a physical object such as a vehicle in the immediate vicinity of the sensor; that is, the sensing device may be a passive infrared motion sensor or infrared reflector sensor.

Power to the light source is removed, i.e., the lighting device is turned off, in any of a number of ways, such as immediately after entry of an operative code into the keypad or release of the call button, or after a predetermined delay controlled by simple pulse counting or other logic. Pulse counting may also be utilized to avoid false triggering by motions outside the predetermined range and rising warm air. The system may further include means for modulating the light source to a lower duty cycle in order to save power without loss of the perceived amount of light. The device consumes very little power and may operate on battery or solar-provided electricity.

The foregoing and other features of construction and operation of the invention will be more readily understood and fully appreciated from the following detailed disclosure, taken in conjunction with the accompanying drawings.

### BRIEF DESCRIPTION OF THE DRAWINGS

FIG. 1 is an illustration of an example of physical components utilized in the practice of the invention;

FIG. 1A is a side elevation of one of the elements of FIG. 1 in an alternate embodiment;

FIG. 2 is a partly diagrammatic, partly electrical schematic illustration of an embodiment of the invention; and

FIG. 3 is a flow chart showing the sequence of operative events in a typical application of the invention.

### DETAILED DESCIPTION

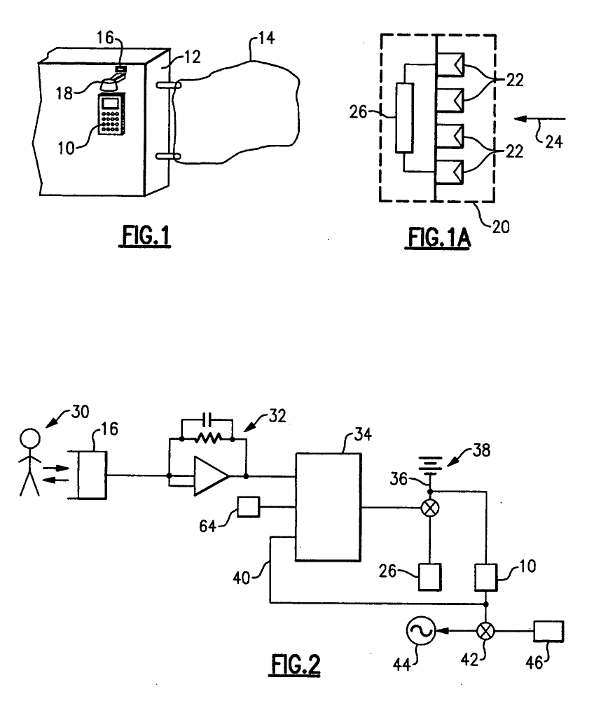

In FIG. 1 is shown a human interface input device in the form of keypad 10, in this case permanently mounted upon structure such as gate support structure 12. conventional electromechanical apparatus controls opening movement of gate 14 in response to manual actuation of selected keys of keypad 10 in a predetermined sequence, i.e., in response to entry of a predetermined code. Such systems work well to control access to various premises, permitting those with knowledge of the code to obtain access upon proper manipulation of the keypad. However, such keypads or other human interface input devices are often installed in locations where the ambient light level, at least at certain hours, is insufficient to enable a person with standard vision to visually identify the individual keys or, for that matter, to easily find the location of a single manual contact device such as a call button.

The present invention contemplates the provision of a light source in the vicinity of keypad 10 which is automatically illuminated in response to the presence or motion of a person and/or, if desired, a vehicle, in the immediate vicinity of a sensing device. For purposes of the present disclosure, sensor 16 will be considered a passive infrared motion detector, mounted upon gate support structure 12, as is light source 18. As an individual, or other moving body, approaches sensor 16, a signal is generated and is used to actuate light source 18, thereby illuminating keypad 10. Upon expiration of a predetermined time period following initial actuation without sensing of further motion by the IR-emitting body, the signal actuating light source 18 is removed. Alternatively, the entry of a proper code, i.e., actuation of a predetermined sequence of keys on keypad 10, may serve to remove the signal providing illumination, thereby interrupting power to light source 18.

In an alternate embodiment, shown in FIG. 1A, casing or frame 20 of the keypad is illustrated in phantom lines and supports keys 22, which are actuated from the front side, indicated by arrow 24, and light source 26 on the opposite side; various diffusing elements are available, if required, to distribute the light in a manner providing backlighting rendering all keys visually distinguishable from the front side.

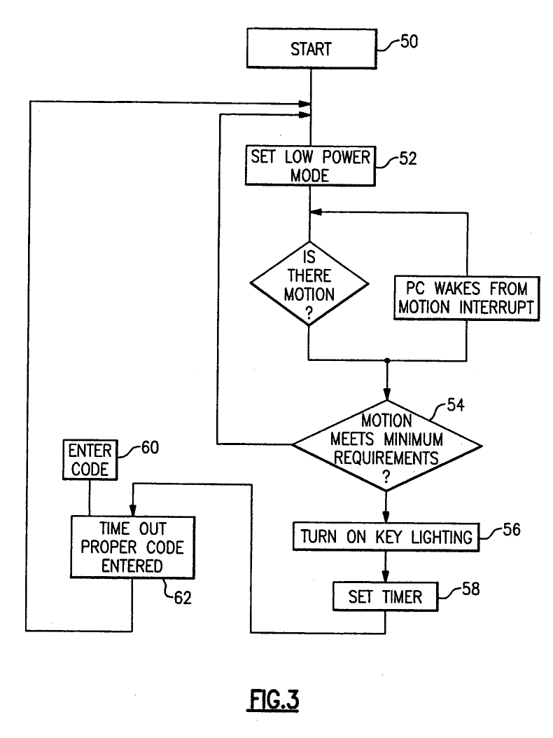

An embodiment of the system circuitry is shown in FIG. 2. A threshold level of motion, e.g., by person 30, produces an electrical signal in sensor 16 which is appropriately processed by amplifier/filter 32. A simple micro-controller 34 receives the signal from the amplifier/filter and actuates switching device 36, connecting battery 38 with light source 26. Micro-controller 34 may be configured to perform a timing operation, e.g., a pulse count, beginning with initial actuation and interrupting power to switching device 36 after a predetermined time period. Alternatively, or in addition to the timing operation, a signal may be provided to controller 34 on line 40 upon entry of a proper sequence of key operations, i.e., a predetermined code, on keypad 10 to interrupt the signal to switching device 36 and thus to light source 26. Since visual identification of individual keys is no longer required once the proper code has been entered on the keypad, the light source is turned off as soon as the code is entered. The signal provided in response to entry of the proper code is provided to switching device 42, connecting power source 44 to gate actuator 46.

The flow diagram of FIG. 3 shows the sequence of events in a typical application of the lighting system of the invention. The start of operational capability is indicated by block 50. The system is set in low power mode, as indicated by block 52 and the sensor/motion detector generates a signal in response to physical presence or motion which meets the predetermined threshold level. (block 54). The light source is actuated to provide illumination of the keys (block 56) and the timing operation begins (block 58). The keys are operated to enter the predetermined code (block 60) and, after the proper code has been entered or the predetermined time period has expired, whichever occurs first, (block 62) power to the light source is interrupted and the system is returned to its initial state.

The lighting system may be operated at all times in response to sensed presence or motion in the immediate vicinity of the keypad, or only during times when the ambient light level is below a threshold value. Referring again to FIG. 2, device 64 is a conventional photosensor which responds to light intensity and blocks micro-controller 34 from emitting a signal when the light level is below the established value.

Although the invention has been described in the context of a keypad, it will be understood that it is applicable to any human interface input, including single as well as multiple keys or buttons.

What is claimed is;:

1. A human interface input system with means facilitating operation under conditions of low ambient light, said system comprising:
a. at least one manually operable key or button;
b. a light source actuable to illuminate said key or button;
c. a sensor operable to generate an electrical signal in response to at least one of physical presence and motion of an infrared-emitting object in the immediate vicinity of said sensor; and
d. means for actuating said light source in response to generation of said electrical signal.

2. The system of claim 1 wherein said key or button is actuable by an operator positioned on one side of said key or button, and wherein said light source is positioned on said one side for direct, frontal illumination of said key or button.

3. The system of claim 1 wherein said key or button is actuable by an operator positioned on one side of said key or button, and wherein said light source is positioned on the other side for backlighting of said key or button.

4. The system of claim 1 wherein said at least one key or button comprises a keypad having multiple keys.

5. The system of claim 4 wherein said keypad includes coding means establishing a predetermined sequence of operation of two or more of said keys.

6. The system of claim 5 and further including an actuator operable in response to said predetermined sequence of operation of said keys.

7. The system of claim 1 and further including means for deactivating said light source upon occurrence of a predetermined event following actuation thereof.

8. The system of claim 7 and further including pulse generating means, and wherein said event comprises a predetermined count of pulses following actuation of said light source.

9. The system of claim 7 wherein said key or button comprises a keypad having multiple keys and coding means establishing a predetermined sequence of operation of said keys, and wherein said light source is deactivated in response to operation of said keys in said predetermined sequence.

10. The system of claim 1 and further including a battery connected through a first switching device with said light source for supplying power to illuminate said light source in response to actuation of said first switching device.

11. The system of claim 10 and further including a microcontroller electrically interposed between said sensor and said first switching means to actuate said first switching means in response to generation of said electrical signal by said sensor.

12. The system of claim 11 wherein said microcontroller generates a pulse count and further including means for deactivating said first switching device in response to a predetermined pulse count following actuation of said first switching device.

13. A system for limiting physical access to a designated area, said system comprising:
a. a movable barrier having a first position, barring access to said area, and a second position, permitting access to said area;
b. an actuator operable to move said barrier between said first and second positions thereof;
c. first and second power sources;
d. first and second switching devices;
e. a sensor for generating an electrical signal in response to one of physical presence and motion of an infra-red emitting object in proximity to said sensor
f. a keypad having multiple, manually operated keys connected between said first power source and said second switching device, said keypad being operative to connect said first power source to said second switching device in response to operation of said keys in a predetermined sequence;
g. a light source actuable by said first power source to illuminate said keys for visual identification thereof;
h. said first switching device being actuable in response to said electrical signal to connect said first power source with said light source for actuation thereof; and
i. said second power source being connected to said actuator through said second switching device whereby, upon connection of said first power source to said second switching device in response to operation of said keys in said predetermined sequence, said actuator is connected through said second switching device to said actuator, thereby moving said barrier from said first to said second position thereof.

14. The system of claim 13 wherein said barrier is a gate.

15. The system of claim 13 wherein said first power source is a battery.

16. The system of claim 15 wherein said second power source is a source of alternating current.

17. The system of claim 13 and further including a microcontroller electrically interposed between said sensor and said first switching device to allow or prevent said electrical signal from actuating said first switching device to connect said first power source with said light source.

18. The system of claim 17 wherein said keypad is electrically connected to said microcontroller to prevent said electrical signal from actuating said first switching device in response to operation of said keys in said predetermined sequence, thereby deactivating said light source immediately following said operation of said keys.

19. The system of claim 17 wherein said microcontroller generates pulses and operates to prevent said electrical signal from actuating said first switching device in response to generation of a predetermined number of pulses following actuation of said first switching device.

20. The system of claim 17 and further including a photosensor electrically connected to said microcontroller to prevent said electrical signal from actuating said first switching means when ambient light is above a predetermined level.
